(19) United States
(12) Patent Application Publication
(10) Pub. No.: US 2025/0351012 A1
(43) Pub. Date: Nov. 13, 2025

(54) Enhancements for Wireless Devices Moving from Edge to Cloud Data Networks

(71) Applicant: Apple Inc., Cupertino, CA (US)

(72) Inventors: Mona Agnel, London (GB); Haijing Hu, Los Gatos, CA (US); Ralf Rossbach, Neubiberg (DE); Vivek G Gupta, San Jose, CA (US); Sudeep Manithara Vamanan, Munich (DE); Shu Guo, Beijing (CN); Dawei Zhang, Saratoga, CA (US); Robert Zaus, Munich (DE)

(21) Appl. No.: 18/859,508

(22) PCT Filed: May 6, 2022
(86) PCT No.: PCT/CN2022/091085

§ 371 Date: Oct. 23, 2024

(51) Int. Cl. H04W 36/00; H04L 61/4511; H04W 24/08; H04W 48/16; H04W 48/18

(52) U.S. Cl. CPC H04W 36/0033; H04L 61/4511; H04W 24/08; H04W 48/16; H04W 48/18

(57) ABSTRACT

A user equipment (UE) can be configured to detect a mobility event of the UE in which the mobility event corresponds to the UE moving from a first service area which supports one or more edge application servers (EAS) to a second service area which supports one or more cloud application servers (CAS). The UE can then perform communications with an edge configuration server (ECS) regarding the second service area. Additionally, the UE can receive from the ECS, a response comprising an indication that one or more suitable edge data networks (EDNs) could not be found. The UE can discover a suitable CAS corresponding to the second service area and perform an application context transfer (ACT) from the EAS to the CAS.

### PRIORITY INFORMATION

This application is a national stage entry of PCT Application No. PCT/CN2022/091085, entitled “Enhancements for Wireless Devices Moving from Edge to Cloud Data Networks,” filed May 6, 2022, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### TECHNICAL FIELD

The present application relates to wireless communication, including enhancements regarding user equipment service continuity when moving between edge to cloud data networks.

### DESCRIPTION OF THE RELATED ART

Wireless communication systems are rapidly growing in usage. Further, wireless communication technology has evolved from voice-only communications to also include the transmission of data, such as Internet and multimedia content.

Mobile electronic devices can take the form of smart phones or tablets that a user typically carries. Wearable devices (also referred to as accessory devices) are a newer form of mobile electronic device, one example being smart watches. Additionally, low-cost, low-complexity wireless devices intended for stationary or nomadic deployment are also proliferating as part of the developing “Internet of Things”. In other words, there is an increasingly wide range of desired device complexities, capabilities, traffic patterns, and other characteristics. In general, it would be desirable to recognize and provide improved support for a broad range of desired wireless communication characteristics. One characteristic can be enhancing communication between wireless devices, edge servers, and cloud servers when moving between service areas associated with said edge and cloud servers. Improvements in the field are desired.

### SUMMARY

Embodiments are presented herein of, inter alia, systems, apparatuses, and methods for performing application context relocation between edge and cloud application servers and related communications in a wireless communication system, e.g., New Radio (NR), LTE, etc.

As noted above, the number of use cases for wireless networks communicating with different classes of user equipment devices (UEs) with widely variable capabilities and usage expectations are growing. One usage expectation can include a UE performing application context relocation between edge and cloud application servers.

In some embodiments, a method performed by a user equipment (UE) can include detecting a mobility event of the UE in which corresponds to the UE moving from a first service area which supports one or more edge application servers (EAS) to a second service area which may not support any EAS but instead supports one or more cloud application servers (CAS). The UE can then perform communications with an edge configuration server (ECS) regarding the second service area, according to some embodiments. Additionally or alternatively, the UE can receive from the ECS, a response comprising an indication that one or more suitable edge data networks (EDNs) could not be found, according to some embodiments. In some embodiments, the UE can discover a suitable CAS corresponding to the second service area and perform an application context transfer (ACT) from the EAS to the CAS.

According to some embodiments, the communications with the ECS can include performing a service provisioning procedure corresponding to the second service area. Additionally or alternatively, the service provisioning procedure can include querying the ECS in order to find the one or more suitable EDNs, according to some embodiments. In some embodiments, the service provisioning procedure can be triggered by the ECS when a location of the UE is provided to the ECS by a cellular network entity via an EDGE-8 interface using a UE location application programming interface (API).

According to further embodiments, a suitability of the one or more suitable EDNs can be based on at least one of a location and an application client (AC) profile of the UE. Additionally or alternatively, the response from the ECS can include a service provisioning response, according to some embodiments. In some embodiments, the response can comprise configuration information including at least one of internet protocol (IP) addresses, data network names (DNN), single network slice selection assistance information (S-NSSAI), and service areas corresponding to the suitable CAS of the one or more CAS. Additionally or alternatively, the response can comprise a failure response.

In some embodiments, the UE can comprise an edge enabler client (EEC) and an application client (AC) and the method can further comprise informing, via the EEC, the AC that the one or more suitable EDNs were not found. Additionally or alternatively, the method can further comprise informing, via the EEC, the AC of a failure to find a suitable EDN by sending the AC a notification message with an indication of the failure to find the suitable EDN. According to some embodiments, the method can further comprise forwarding, via the EEC, the response from the ECS to the AC.

In some embodiments, the receipt of the indication by the AC can trigger the discovery of the CAS using available or existing mechanisms. According to some embodiments, the available or existing mechanisms can use a domain name system (DNS) with a fully qualified domain name (FQDN) of the CAS in order to discover the CAS. Additionally or alternatively, the available or existing mechanisms can involve the AC using the fully qualified domain name (FQDN) of the CAS via a domain name system (DNS) query to discover the CAS, according to some embodiments. In some embodiments, the AC can be triggered by the EEC to start the ACT.

According to further embodiments, a method for operating an edge configuration server (ECS) can comprise establishing communication with a user equipment (UE). Additionally or alternatively, the method for operating the ECS can further comprise receiving, from the UE, a message indicating a mobility event of the UE, wherein the mobility event corresponds to the UE moving from a first service area which supports one or more edge application servers (EAS) to a second service area which supports one or more cloud application servers (CAS), according to some embodiments. In some embodiments, the method for operating the ECS can further include transmitting, to the UE, a response comprising at least one of an indication that a suitable EDN could not be found and information corresponding to one or more suitable CAS. Additionally or alternatively, the information corresponding to the one or more suitable CAS can be useable by the UE in performing an application context transfer (ACT) from the EAS to the CAS. As one possibility, the method of operating the ECS can further include receiving, from a cellular network entity and via an EDGE-8 interface using a UE location application programming interface (API), information corresponding to the mobility event of the UE.

The techniques described herein can be implemented in and/or used with a number of different types of devices, including but not limited to cellular phones, tablet computers, wearable computing devices, portable media players, and any of various other computing devices.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the embodiments is considered in conjunction with the following drawings.

FIG. 1 illustrates an example wireless communication system including an accessory device, according to some embodiments;

FIG. 2 illustrates an example wireless communication system in which two wireless devices can perform direct device-to-device communication, according to some embodiments;

FIG. 3 is a block diagram illustrating an example wireless device, according to some embodiments;

FIG. 4 is a block diagram illustrating an example base station, according to some embodiments;

FIG. 5 is a block diagram illustrating an example edge computing architecture, according to some embodiments;

FIG. 6 is a block diagram illustrating UE Mobility and Service Continuity from EDN to Cloud, according to some embodiments;

FIG. 7 is a communication flow diagram illustrating example communications for performing ACR between EAS and CAS, according to some embodiments; and

FIG. 8 is a phase diagram illustrating an example method for ACR between EAS and CAS, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms and Abbreviations

The following acronyms and abbreviations are used in the present disclosure.
3GPP: Third Generation Partnership Project
3GPP2: Third Generation Partnership Project 2
GSM: Global System for Mobile Communications
GSMA: GSM Association
ITU: International Telecommunication Union
UMTS: Universal Mobile Telecommunications System
LTE: Long Term Evolution
RRC: Radio Resource Control
MAC: Media Access Control
CE: Control Element
Tx: Transmission (or transmit)
Rx: Reception (or receive)
RS: Reference Signal
CSI: Channel State Information
ECS: Edge Configuration Server
EEC: Edge Enabler Client
EES: Edge Enabler Server
S-EES: source Edge Enabler Server
EEC ID: Edge Enabler Client Identifier
EDN: Edge Data Network
CAS: Cloud Application Server
EAS: Edge Application Server
S-EAS: Source Edge Application Server
AC: Application Client
ACR: Application Context Relocation
ACT: Application Context Transfer
EEL: Edge Enabler Layer
FQDN: Fully Qualified Domain Name
DNS: Domain Name System

### Terminology

The following are definitions of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium can include other types of non-transitory memory as well or combinations thereof. In addition, the memory medium can be located in a first computer system in which the programs are executed, or can be located in a second different computer system which connects to the first computer system over a network, such as the Internet. In the latter instance, the second computer system can provide program instructions to the first computer for execution. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks can range from fine grained (combinatorial logic or look up tables) to coarse grained (arithmetic logic units or processor cores). A programmable hardware element can also be referred to as “reconfigurable logic”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, vehicle, automobile, unmanned aerial vehicles (e.g., drones) and unmanned aerial controllers, etc. In general, the term “UE” or “UE device” can be broadly defined to encompass any electronic, computing, and/or telecommunications device (or combination of devices) which is easily transported by a user and capable of wireless communication.

Wireless Device—any of various types of computer systems or devices that perform wireless communications. A wireless device can be portable (or mobile) or can be stationary or fixed at a certain location. A UE is an example of a wireless device.

Communication Device—any of various types of computer systems or devices that perform communications, where the communications can be wired or wireless. A communication device can be portable (or mobile) or can be stationary or fixed at a certain location. A wireless device is an example of a communication device. A UE is another example of a communication device.

Base Station—The term “Base Station” has the full breadth of its ordinary meaning, and at least includes a wireless communication station installed at a fixed location and used to communicate as part of a wireless communication system.

Link Budget Limited—includes the full breadth of its ordinary meaning, and at least includes a characteristic of a wireless device (e.g., a UE) which exhibits limited communication capabilities, or limited power, relative to a device that is not link budget limited, or relative to devices for which a radio access technology (RAT) standard has been developed. A wireless device that is link budget limited can experience relatively limited reception and/or transmission capabilities, which can be due to one or more factors such as device design, device size, battery size, antenna size or design, transmit power, receive power, current transmission medium conditions, and/or other factors. Such devices can be referred to herein as “link budget limited” (or “link budget constrained”) devices. A device can be inherently link budget limited due to its size, battery power, and/or transmit/receive power. For example, a smart watch that is communicating over LTE or LTE-A with a base station can be inherently link budget limited due to its reduced transmit/receive power and/or reduced antenna. Wearable devices, such as smart watches, are generally link budget limited devices. Alternatively, a device may not be inherently link budget limited, e.g., can have sufficient size, battery power, and/or transmit/receive power for normal communications over LTE or LTE-A, but can be temporarily link budget limited due to current communication conditions, e.g., a smart phone being at the edge of a cell, etc. It is noted that the term “link budget limited” includes or encompasses power limitations, and thus a power limited device can be considered a link budget limited device.

Processing Element (or Processor)—refers to various elements or combinations of elements that are capable of performing a function in a device, e.g., in a user equipment device or in a cellular network device. Processing elements can include, for example: processors and associated memory, portions or circuits of individual processor cores, entire processor cores, individual processors, processor arrays, circuits such as an ASIC (Application Specific Integrated Circuit), programmable hardware elements such as a field programmable gate array (FPGA), as well as any of various combinations of the above.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure can be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form can be automatically filled out by the computer system where the computer system (e.g., software executing on the computer system) analyzes the fields of the form and fills in the form without any user input specifying the answers to the fields. As indicated above, the user can invoke the automatic filling of the form, but is not involved in the actual filling of the form (e.g., the user is not manually specifying answers to fields but rather they are being automatically completed). The present specification provides various examples of operations being automatically performed in response to actions the user has taken.

Configured to—Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

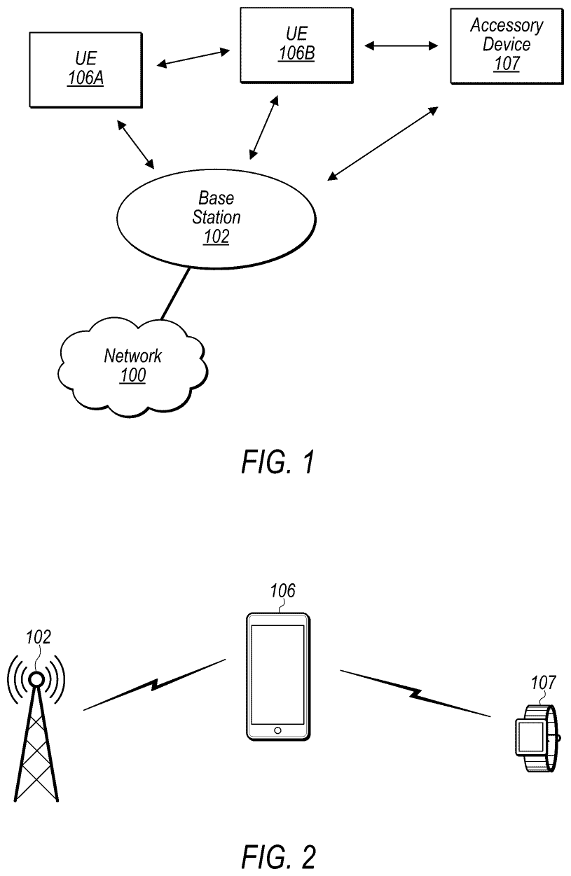

### FIGS. 1-2—Wireless Communication System

FIG. 1 illustrates an example of a wireless cellular communication system. It is noted that FIG. 1 represents one possibility among many, and that features of the present disclosure can be implemented in any of various systems, as desired. For example, embodiments described herein can be implemented in any type of wireless device.

As shown, the exemplary wireless communication system includes a cellular base station 102, which communicates over a transmission medium with one or more wireless devices 106A, 106B, etc., as well as accessory device 107. Wireless devices 106A, 106B, and 107 can be user devices, which can be referred to herein as “user equipment” (UE) or UE devices.

The base station 102 can be a base transceiver station (BTS) or cell site, and can include hardware and/or software that enables wireless communication with the UE devices 106A, 106B, and 107. If the base station 102 is implemented in the context of LTE, it can alternately be referred to as an ‘eNodeB’ or ‘eNB’. If the base station 102 is implemented in the context of 5G NR, it can alternately be referred to as a ‘gNodeB’ or ‘gNB’. The base station 102 can also be equipped to communicate with a network 100 (e.g., a core network of a cellular service provider, a telecommunication network such as a public switched telephone network (PSTN), and/or the Internet, among various possibilities). Thus, the base station 102 can facilitate communication among the UE devices 106 and 107 and/or between the UE devices 106/107 and the network 100. As also used herein, from the perspective of UEs, a base station can sometimes be considered as representing the network insofar as uplink (UL) and downlink (DL) communications of the UE are concerned. Thus, a UE communicating with one or more base stations in the network can also be interpreted as the UE communicating with the network.

In other implementations, base station 102 can be configured to provide communications over one or more other wireless technologies, such as an access point supporting one or more WLAN protocols, such as 802.11 a, b, g, n, ac, ad, and/or ax, or LTE in an unlicensed band (LAA).

The communication area (or coverage area) of the base station 102 can be referred to as a “cell.” The base station 102 and the UEs 106/107 can be configured to communicate over the transmission medium using any of various radio access technologies (RATs) or wireless communication technologies, such as LTE, LTE-Advanced (LTE-A), NR, HSPA, Wi-Fi, ultra-wideband (UWB), etc.

Base station 102 and other similar base stations (not shown) operating according to one or more cellular communication technologies can thus be provided as a network of cells, which can provide continuous or nearly continuous overlapping service to UE devices 106A-N and 107 and similar devices over a geographic area via one or more cellular communication technologies.

Note that at least in some instances a UE device 106/107 can be capable of communicating using any of multiple wireless communication technologies. For example, a UE device 106/107 might be configured to communicate using one or more of LTE, LTE-A, NR, WLAN, UWB, Bluetooth, one or more global navigational satellite systems (GNSS, e.g., GPS or GLONASS), one and/or more mobile television broadcasting standards (e.g., ATSC-M/H), etc. Other combinations of wireless communication technologies (including more than two wireless communication technologies) are also possible. Likewise, in some instances a UE device 106/107 can be configured to communicate using only a single wireless communication technology.

The UEs 106A and 106B can include handheld devices such as smart phones or tablets, and/or can include any of various types of device with cellular communications capability. For example, one or more of the UEs 106A and 106B can be a wireless device intended for stationary or nomadic deployment such as an appliance, measurement device, control device, etc. The UE 106B can be configured to communicate with the UE device 107, which can be referred to as an accessory device 107. The accessory device 107 can be any of various types of wireless devices, typically a wearable device that has a smaller form factor, and can have limited battery, output power and/or communications abilities relative to UEs 106. As one common example, the UE 106B can be a smart phone carried by a user, and the accessory device 107 can be a smart watch worn by that same user. The UE 106B and the accessory device 107 can communicate using any of various short range communication protocols, such as Bluetooth or Wi-Fi. In some instances, the UE 106B and the accessory device 107 can perform direct peer-to-peer communication using proximity services (ProSe) techniques, e.g., in a manner supported by a cellular base station. For example, such ProSe communication can be performed as part of a relay link to support a radio resource control connection between the accessory device 107 and the BS 102, such as according to various embodiments described herein.

The UE 106B can also be configured to communicate with the UE 106A. For example, the UE 106A and UE 106B can be capable of performing direct device-to-device (D2D) communication. The D2D communication can be supported by the cellular base station 102 (e.g., the BS 102 can facilitate discovery, among various possible forms of assistance), or can be performed in a manner unsupported by the BS 102. For example, it can be the case that the UE 106A and UE 106B are capable of arranging and performing D2D communication (e.g., including discovery communications) with each other even when out-of-coverage of the BS 102 and other cellular base stations.

The BS 102 can control one or more transmission and reception points (TRPs) and can use the TRPs to communicate with the UEs. The TRPs can be collocated with the BS and/or at separate physical locations.

FIG. 2 illustrates an example BS 102 in communication with a UE device 106, which in turn is in communication with an accessory device 107. The UE device 106 and accessory device 107 can be any of a mobile phone, a tablet, or any other type of hand-held device, a smart watch or other wearable device, a media player, a computer, a laptop, unmanned aerial vehicle (UAV), unmanned aerial controller, vehicle, or virtually any type of wireless device. In some embodiments, the accessory device can be a wireless device designed to have low cost and/or low power consumption, and which can benefit from use of a relay link with the UE device 106 (and/or another companion device) to support communication with the BS 102. A device that utilizes a relay link with another wireless device to communicate with a cellular base station, such as in the illustrated scenario of FIG. 2, can also be referred to herein as a remote wireless device, a remote device, or a remote UE device, while a wireless device that provides such a relay link can also be referred to herein as a relay wireless device, a relay device, or relay UE device. According to some embodiments, such a BS 102, UE 106, and accessory device 107 can be configured to perform radio resource control procedures for remote wireless devices in accordance with various of the techniques described herein.

The UE 106 and accessory device 107 can each include a device or integrated circuit for facilitating cellular communication, referred to as a cellular modem. The cellular modem can include one or more processors (processing elements) that is configured to execute program instructions stored in memory, and/or various hardware components as described herein. The UE 106 and/or accessory device 107 can each perform any of the method embodiments described herein by executing such stored instructions. Alternatively, or in addition, the UE 106 and/or accessory device 107 can include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The cellular modem described herein can be used in a UE device as defined herein, a wireless device as defined herein, or a communication device as defined herein. The cellular modem described herein can also be used in a base station or other similar network side device.

The UE 106 and/or accessory device 107 can include one or more antennas for communicating using one or more wireless communication protocols according to one or more RAT standards. In some embodiments, one or both of the UE 106 or accessory device 107 might be configured to communicate using a single shared radio. The shared radio can couple to a single antenna, or can couple to multiple antennas (e.g., for MIMO) for performing wireless communications. In general, a radio can include any combination of a baseband processor, analog RF signal processing circuitry (e.g., including filters, mixers, oscillators, amplifiers, etc.), or digital processing circuitry (e.g., for digital modulation as well as other digital processing). Similarly, the radio can implement one or more receive and transmit chains using the aforementioned hardware.

Alternatively, the UE 106 and/or accessory device 107 can include two or more radios. For example, in some embodiments, the UE 106 and/or accessory device 107 can include separate transmit and/or receive chains (e.g., including separate antennas and other radio components) for each wireless communication protocol with which it is configured to communicate. As a further possibility, the UE 106 and/or accessory device 107 can include one or more radios that are shared between multiple wireless communication protocols, and one or more radios that are used exclusively by a single wireless communication protocol. For example, the UE 106 and/or accessory device 107 can include a shared radio for communicating using either of LTE or NR, and separate radios for communicating using each of UWB, Wi-Fi and BLUETOOTH™. Other configurations are also possible.

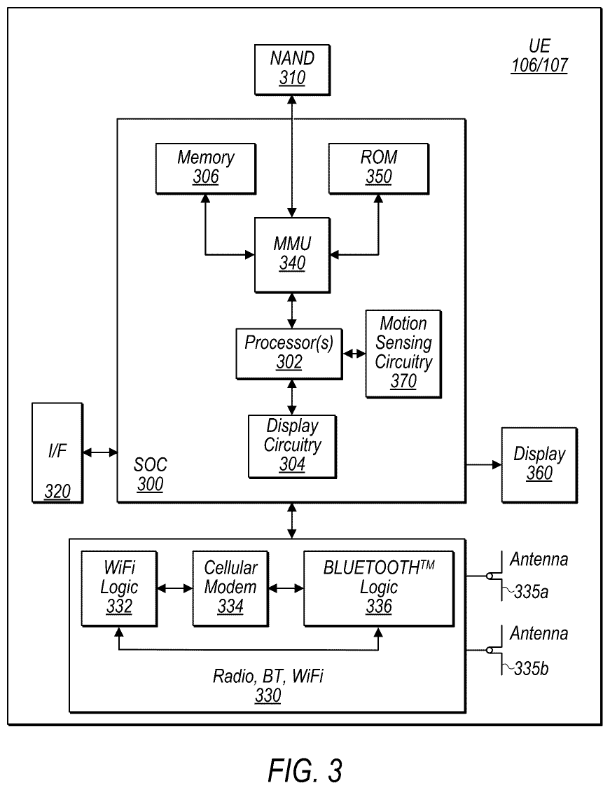

### FIG. 3—Block Diagram of a UE Device

FIG. 3 illustrates one possible block diagram of a UE device, such as UE device 106 or 107. As shown, the UE device 106/107 can include a system on chip (SOC) 300, which can include portions for various purposes. For example, as shown, the SOC 300 can include processor(s) 302 which can execute program instructions for the UE device 106/107, and display circuitry 304 which can perform graphics processing and provide display signals to the display 360. The SOC 300 can also include motion sensing circuitry 370 which can detect motion of the UE 106, for example using a gyroscope, accelerometer, and/or any of various other motion sensing components. The processor(s) 302 can also be coupled to memory management unit (MMU) 340, which can be configured to receive addresses from the processor(s) 302 and translate those addresses to locations in memory (e.g., memory 306, read only memory (ROM) 350, NAND flash memory 310), and/or to other circuits or devices, such as the display circuitry 304, radio 330, I/F 320, and/or display 360. The MMU 340 can be configured to perform memory protection and page table translation or set up. In some embodiments, the MMU 340 can be included as a portion of the processor(s) 302.

As shown, the SOC 300 can be coupled to various other circuits of the UE 106/107. For example, the UE 106/107 can include various types of memory (e.g., including NAND flash memory 310), a connector interface 320 (e.g., for coupling to a computer system, dock, charging station, etc.), the display 360, and wireless communication circuitry 330 (e.g., for LTE, LTE-A, NR, Bluetooth, Wi-Fi, NFC, UWB, GPS, etc.).

The UE device 106/107 can include at least one antenna, and in some embodiments multiple antennas 335a and 335b, for performing wireless communication with base stations and/or other devices. For example, the UE device 106/107 can use antennas 335a and 335b to perform the wireless communication. As noted above, the UE device 106/107 can in some embodiments be configured to communicate wirelessly using multiple wireless communication standards or radio access technologies (RATs).

The wireless communication circuitry 330 can include Wi-Fi Logic 332, a Cellular Modem 334, and Bluetooth Logic 336. The Wi-Fi Logic 332 is for enabling the UE device 106/107 to perform Wi-Fi communications on an 802.11 network. The Bluetooth Logic 336 is for enabling the UE device 106/107 to perform Bluetooth communications. The cellular modem 334 can be a lower power cellular modem capable of performing cellular communication according to one or more cellular communication technologies.

As described herein, UE 106/107 can include hardware and software components for implementing embodiments of this disclosure. The processor(s) 302 of the UE device 106/107 can be configured to implement part or all of the methods described herein, e.g., by executing program instructions stored on a memory medium (e.g., a non-transitory computer-readable memory medium). In other embodiments, processor(s) 302 can be configured as a programmable hardware element, such as an FPGA (Field Programmable Gate Array), or as an ASIC (Application Specific Integrated Circuit). Furthermore, processor(s) 302 can be coupled to and/or can interoperate with other components as shown in FIG. 3, to perform radio resource control procedures for remote wireless devices according to various embodiments disclosed herein. Processor(s) 302 can also implement various other applications and/or end-user applications running on UE 106. Alternatively or additionally, one or more components of the wireless communication circuitry 330 (e.g., cellular modem 334) of the UE device 106/107 can be configured to implement part or all of the methods described herein, e.g., by a processor executing program instructions stored on a memory medium (e.g., a non-transitory computer-readable memory medium), a processor configured as an FPGA (Field Programmable Gate Array), and/or using dedicated hardware components, which can include an ASIC (Application Specific Integrated Circuit).

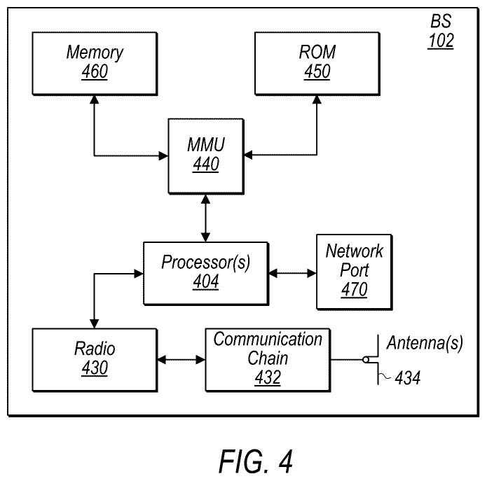

### FIG. 4—Block Diagram of a Base Station

FIG. 4 illustrates an example block diagram of a base station 102, according to some embodiments. It is noted that the base station of FIG. 4 is merely one example of a possible base station. As shown, the base station 102 can include processor(s) 404 which can execute program instructions for the base station 102. The processor(s) 404 can also be coupled to memory management unit (MMU) 440, which can be configured to receive addresses from the processor(s) 404 and translate those addresses to locations in memory (e.g., memory 460 and read only memory (ROM) 450) or to other circuits or devices.

The base station 102 can include at least one network port 470. The network port 470 can be configured to couple to a telephone network and provide a plurality of devices, such as UE devices 106/107, access to the telephone network as described above in FIGS. 1 and 2.

The network port 470 (or an additional network port) can also or alternatively be configured to couple to a cellular network, e.g., a core network of a cellular service provider. The core network can provide mobility related services and/or other services to a plurality of devices, such as UE devices 106/107. For example, the core network can include a mobility management entity (MME), e.g., for providing mobility management services, a serving gateway (SGW) and/or packet data network gateway (PGW), e.g., for providing external data connections such as to the Internet, etc. In some cases, the network port 470 can couple to a telephone network via the core network, and/or the core network can provide a telephone network (e.g., among other UE devices serviced by the cellular service provider).

The base station 102 can include at least one antenna 434, and possibly multiple antennas. The antenna(s) 434 can be configured to operate as a wireless transceiver and can be further configured to communicate with UE devices 106/107 via radio 430. The antenna(s) 434 communicates with the radio 430 via communication chain 432. Communication chain 432 can be a receive chain, a transmit chain or both. The radio 430 can be configured to communicate via various wireless communication standards, including, but not limited to, LTE, LTE-A, NR, UWB, Wi-Fi, etc.

The base station 102 can be configured to communicate wirelessly using multiple wireless communication standards. In some instances, the base station 102 can include multiple radios, which can enable the base station 102 to communicate according to multiple wireless communication technologies. For example, as one possibility, the base station 102 can include an LTE radio for performing communication according to LTE as well as a Wi-Fi radio for performing communication according to Wi-Fi. In such a case, the base station 102 can be capable of operating as both an LTE base station and a Wi-Fi access point. As another possibility, the base station 102 can include a multi-mode radio which is capable of performing communications according to any of multiple wireless communication technologies (e.g., LTE and NR, LTE and Wi-Fi, LTE and UWB, etc.). Other configurations are possible.

As described further subsequently herein, the BS 102 can include hardware and software components for implementing or supporting implementation of features described herein. According to some embodiments, the processor 404 of the base station 102 can be configured to implement part or all of the methods described herein, e.g., by executing program instructions stored on a memory medium (e.g., a non-transitory computer-readable memory medium). Alternatively, the processor 404 can be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 can be configured to implement or support implementation of radio resource control procedures for remote wireless devices according to various embodiments disclosed herein, and/or any of various other of the features described herein.

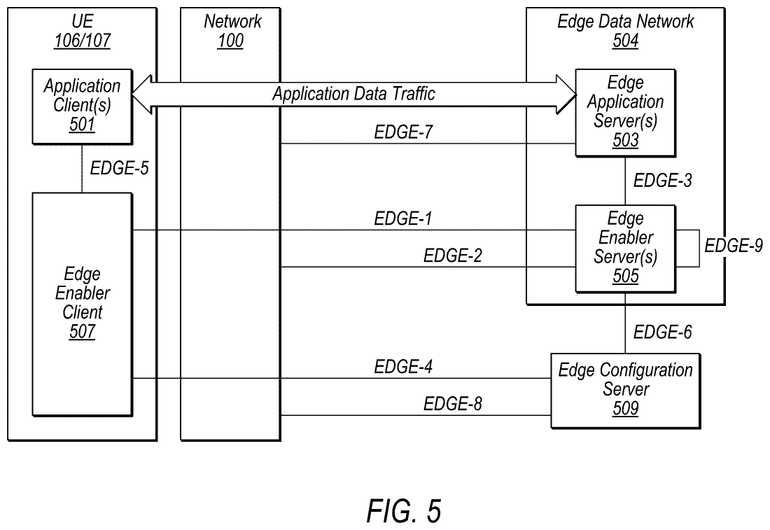

### FIG. 5—Connections Between UEs and Edge Servers

FIG. 5 illustrates an example architecture for enabling edge applications, according to some embodiments. Various edge computing servers can interact with one or more applications (e.g., application client (AC) 501) executing on a UE, according to some embodiments. For example, an edge application server (EAS) 503 can exchange application data with a corresponding application client at the UE. Such exchange of data can occur via any number of intermediate devices. For example, the data can be exchanged via a network 100 such as a 3GPP core network, a 3GPP radio access network (RAN), the internet, and/or a wireless local area network (WLAN), etc., among various possibilities. Example applications that can use EAS include applications for weather, entertainment (e.g., mobile streaming, games), financial services, etc.

An edge data network (EDN) 504 can be a local data network. Any number of edge application server(s) 503 and edge enabler server(s) 505 can be contained within the EDN. An edge enabler server (EES) can be primarily responsible for enabling discovery of the EAS(s) by UEs. Furthermore, the EES can provide information related to edge applications, such as availability and related configuration, to an edge enabler client (EEC). Moreover, the EES can inform or expose capabilities of a 3GPP network to the edge applications. The EEC 507 can provide support functions, such as EAS discovery to the AC(s) 501 in the UE. Furthermore, the EEC can enable discovery of edge applications and provisioning of configuration data. An edge configuration server (ECS) 509 can provide configurations to the EEC to connect with an EES. In other words, the ECS can provide EDN configuration information to the EEC. For example, the ECS can provide configurations related to the EES and/or details of the EDN hosting the EES. Functionalities of an ECS can include provisioning of edge configuration information to the EEC. The edge configuration information can include the following: 1) the information for the EEC to connect to the EES (e.g., service area information applicable to a local area data network (LADN), e.g., for video services); and 2) the information for establishing a connection with EES (e.g., such as a universal resource identifier (URI).

The UE can contain any number of AC(s) and/or EEC(s). For example, one EEC can support one or more AC(s). Functionalities of EEC can include are: a) retrieval and provisioning of configuration information to enable the exchange of application data traffic with the EAS; and b) discovery of EAS(s) available to the UE (e.g., or one or more AC of the UE). An EEC can be identified by an EEC identifier (ID). An EEC ID can be a globally unique value that identifies the EEC. An EEC ID can be allocated by any of various authorities, like GSMA, ITU, 3GPP, and/or manufacturers, etc. An EES can store all the EEC IDs of EECs that can have been registered to the EES. One or more EEC(s) can be located in one UE.

Similarly, one ECS can support one or more EES and/or EDN. One EES can support one or more EAS, e.g., associated with one or more application. The EAS(s), the EES(s), and the ECS(s) can interact with a network such as a 3GPP core network.

As shown, the various entities can be connected by various edge interfaces (e.g., EDGE-1, EDGE-2, etc.). Different EESs can be connected by one or more EDGE-9 interfaces.

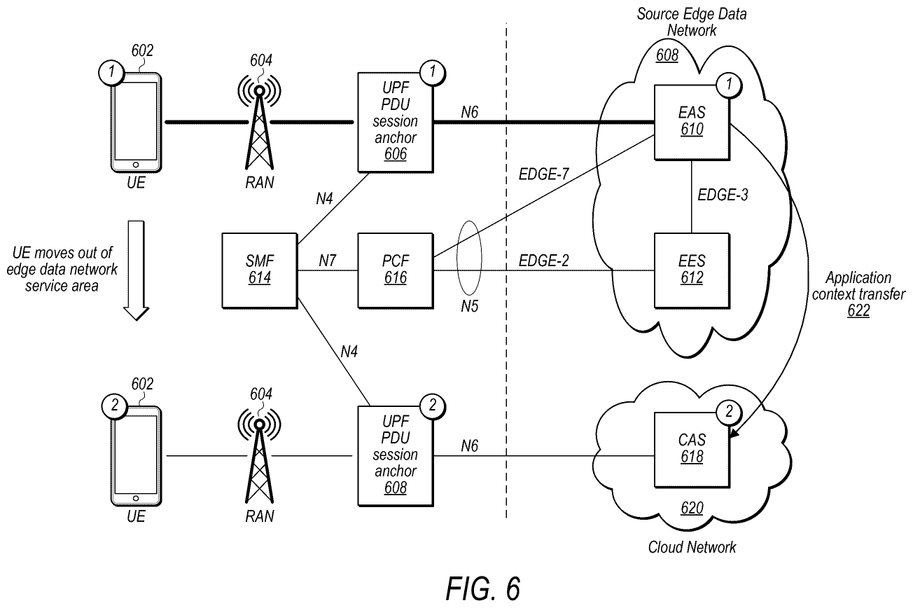

An edge server such as an ECS and/or EES can include one or more network interface operably coupled to one or more processors, according to some embodiments. The one or more processor(s) can be configured to cause the server to perform authentication according to the methods discussed herein, e.g., according to the methods of FIG. 6, as discussed below.

### Enhancements for Wireless Devices Moving Between Edge and Cloud Data Networks

When UEs move between service areas, they can occasionally encounter scenarios in which certain and/or different types of application servers can or may not be supported. For example, one service area can support edge application servers (EAS) while another service area may not support EAS but can only support or provide coverage for cloud application servers (CAS). Moreover, a cloud deployment can or may not require support for an edge enabler layer (EEL) which could potentially impact a CAS architecture. Thus, when a UE moves between said service areas, it is possible that it could encounter service interruptions or disruptions due to the change in supported coverage.

In some scenarios, an edge data network (EDN) can provide coverage to small service areas (e.g., a city or a district) in order to minimize the latency experienced by the end user (e.g., at the UE). This EDN service area can also coincide with a local area data network (LADN), depending on the cellular operator deployment choice. On the other hand, a cloud deployment such as a cloud data network CDN) can provide coverage for a very large service area (e.g. country-wide) and can further be independent from the public land mobility network (PLMN) coverage area. For the cloud deployments, the user latency can depend on the location of the cloud application server (CAS) relative to the end user as well as the route the data traffic has traversed (e.g. in the cellular network). It can be expected that the coverage areas of EDNs may not be contiguous and therefore, as the user moves around, the user can encounter areas that are not covered by EDNs but are in the coverage area of a cloud deployment (e.g., a CDN).

Accordingly, one key issue involves whether and how service continuity can be maintained due to this movement or mobilization of the UE between EAS and CAS service areas. For example, if a UE is running a certain application (e.g., a gaming application) and has stored and/or saved progress in the application, this progress could be lost during a transition in coverage (e.g., from EAS to CAS area, vice versa, or possibly from one EAS/CAS area to a different EAS/CAS area, etc.) due to the aforementioned support issues. In other words, in order to maintain and/or transfer progress or stored application information when transitioning between different types of application servers, a transfer of application related information can be required. More specifically, an application context relocation (ACR) between the EAS and CAS can be required to maintain or provide service continuity for the UE.

### FIG. 6—Application Context Relocation from Edge to Cloud Data Network

FIG. 6 illustrates a basic architecture scheme for an example scenario involving UE service continuity during movement between an edge data network and a cloud network, according to some embodiments. More specifically, FIG. 6 illustrates a scenario in which an application context relocation (ACR) is performed when a UE has geographically transitioned (e.g., has moved to a new location) from a first service area which supports one or more edge data networks to a different or second service area which can only support cloud data network(s). For example, as shown in FIG. 6, a UE 602 running an application can utilize a first user traffic flow path (e.g., Path 1 at the top of FIG. 6) before a mobility event (e.g., a change in location corresponding to an updated service area) occurs. The UE 602 can be in communication with RAN 604 (e.g., a base station) which is further coupled to a source edge data network 608 via a N6 interface connecting a user plane function protocol data unit (UPF PDU) session anchor 606 to an edge application server 610 of the EDN 608.

According to some embodiments, a UPF PDU session anchor can be useful for ACR between two EASs or ACR from an EAS to a CAS. For example, when the UE changes location, a different UPF can be more suitable (to further minimize the latency) so that the path that the data traverses from the UE to the UPF to the application server can be minimized or reduced. More specifically, if the original UPF is kept, the latency can be degraded due to the data traffic having to traverse through the original UPF to the new application server. However, for a UE moving from an EAS supported service area to a CAS supported service area, there may not be a need to relocate the UPF PDU session, according to some embodiments. Additionally or alternatively, a relocation of the UPF PDU session can still be performed if there is a need, according to some embodiments.

The UE and the base station (BS) can communicate using one or more radio access technologies (RATs), e.g., including NR. The UE and the BS can communicate using any frequency resources. The UE and the BS can communicate using one or more frequency carriers, e.g., including licensed and/or unlicensed carriers. The BS can provide one or more cell and/or cell groups and the communication between the UE and the BS can use one or more cell and/or cell group. Additionally or alternatively, the network can exchange configuration information with the UE. For example, the BS can use radio resource control (RRC) and/or other higher layer signaling to negotiate parameters with the UE and/or to configure the UE.

Moreover, the UPF PDU session anchor 606 between the base station and the edge network can be further connected to a session management function (SMF) 614 via an N4 interface and said SMF 614 can be connected to a policy control function (PCF) 616 via an N7 interface. Furthermore, the PCF 616 can be connected to the EAS 610 and EES 612 via a N5 and EDGE-7 interfaces and N5 and EDGE-2 interfaces, respectively. Moreover, the EAS 610 and EES 612 can be coupled via an EDGE-3 interface.

Accordingly, when a UE moves out of the edge data network service area to a service area supported by a cloud network 620 associated with a cloud application server (CAS) 618, the UE can be associated with a new or second user traffic flow path (e.g., Path 2 at the bottom of FIG. 6). For example, the EAS 610 serving the UE can change to the CAS 618 such that the UE's new traffic flow path is characterized by the UE 602 in communication with RAN 604 which is further coupled to a UPF PDU session anchor 606. The UPF PDU session anchor 606 can be further coupled to the CAS 618 of the cloud network 620 via a N6 interface. According to some embodiments, the UPF can change or can remain the same when transferring from an EDN to a CDN. However, in order to maintain service continuity, stateful applications can require application logic to transfer user application context from the source EAS to the CAS. Accordingly, the user traffic flow corresponding to Path 2 can be associated with a UE which has successful completed an application context relocation via an application context transfer 622.

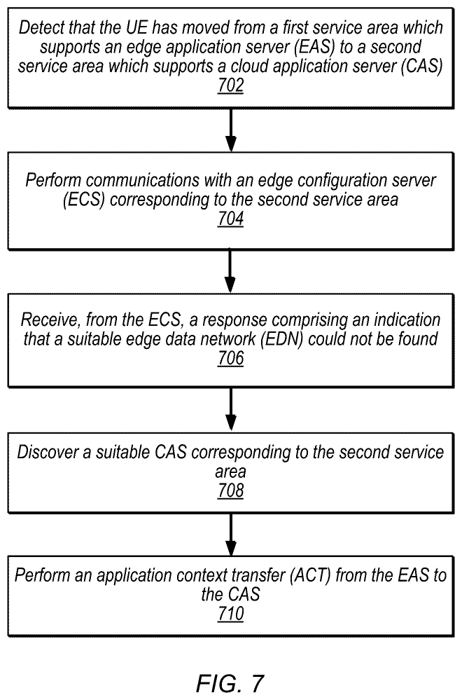

### FIG. 7—Method for Application Context Relocation (ACR) between Edge and Cloud Application Servers

FIG. 7 is a flow chart illustrating an example method for performing an Application Context Relocation (ACR) between Edge and Cloud Application Servers, according to some embodiments. In various embodiments, some of the elements of the methods shown in FIG. 7 can be performed concurrently, in a different order than shown, can be substituted for by other method elements, or can be omitted. It will be appreciated that other orders and combinations are possible. Additional method elements can also be performed as desired.

Aspects of the method of FIG. 7 can be implemented by a UE, such as the UEs 106 or 107), e.g., as illustrated in and described with respect to the Figures, or more generally in conjunction with any of the computer systems, circuitry, elements, components or devices shown in the Figures, among other devices, as desired. For example, one or more processors (or processing elements) (e.g., processor(s) 302, 404, baseband processor(s), processor(s) associated with communication circuitry such as 330, 332, 334, 336, 430, or 432, processors associated with various core network elements and/or edge servers, etc., among various possibilities) can cause a UE to perform some or all of the illustrated method elements. Note that while at least some elements of the method of FIG. 7 are described in a manner relating to the use of communication techniques and/or features associated with RFC, LTE, NR, and/or 3GPP specification documents, such description is not intended to be limiting to the disclosure, and aspects of the method of FIG. 7 can be used in any suitable wireless communication system, as desired. Similarly, while some elements of the method of FIG. 7 are described with respect to application context relocation, it will be appreciated that additional and/or different application context transfer approaches can be used as desired. As shown, the method can operate as follows.

In 702, the UE can detect that the UE has moved from a first service area which supports an edge application server (EAS) to a second service area which supports a cloud application server (CAS) (e.g., from EAS to CAS area, vice versa, or possibly from one EAS/CAS area to a different EAS/CAS area, etc.). This movement to a new service area can be referred to as a mobility event. For example, a UE (e.g., or a relevant application executing on the UE) can be initially being served by an edge data network. When the UE detects an updated location of the UE corresponding to a service area which can only support one or more CAS(s), the UE can determine that the UE has moved (e.g., geographically transitioned to a new location) from an initial or first service area corresponding to the EDN and a corresponding EAS to a new service area which may not support an EDN or EAS. In some embodiments, however, the new or second service area can support a cloud data network (CDN) and/or CAS. As one possibility, the application client (AC) or edge enabler client (EEC) of the UE can make a decision regarding whether or not to perform an application context relocation (ACR) based on the updated UE location. In some embodiments, the EEC (as part of the UE) can detect the mobility event of the UE.

According to some embodiments, the UE or EEC can also be able to detect or predict an expected UE location at a future point in time and/or make a determination about whether or how to perform an ACR can be based in whole or in part on such a prediction.

In 704, the UE can perform a service provisioning procedure corresponding to the updated or new service area (e.g., supporting a CAS), according to some embodiments. The service provisioning procedure can involve the EEC querying the ECS in order to find a suitable Edge Data Network based on one or more factors or parameters including but not limited to UE location and/or an AC profile, according to some embodiments. Based on the information provided by the EEC, the ECS can be configured to determine suitable EDN(s) and EES(s), if any, and provide the EEC information on how the UE can connect to the EDN and EES. For example, the ECS can provide the EEC information including but not limited to one or more data network names (DNNs), single network slice selection assistance information (S-NSSAI) of the EDN, and/or EES endpoints such as uniform resource identifiers (URIs) or internet protocol (IP) addresses). The procedure can be in response to the detection of the past or upcoming mobility event, according to some embodiments. For example, the UE (or EEC of the UE) can perform service provisioning for active applications that require ACR.

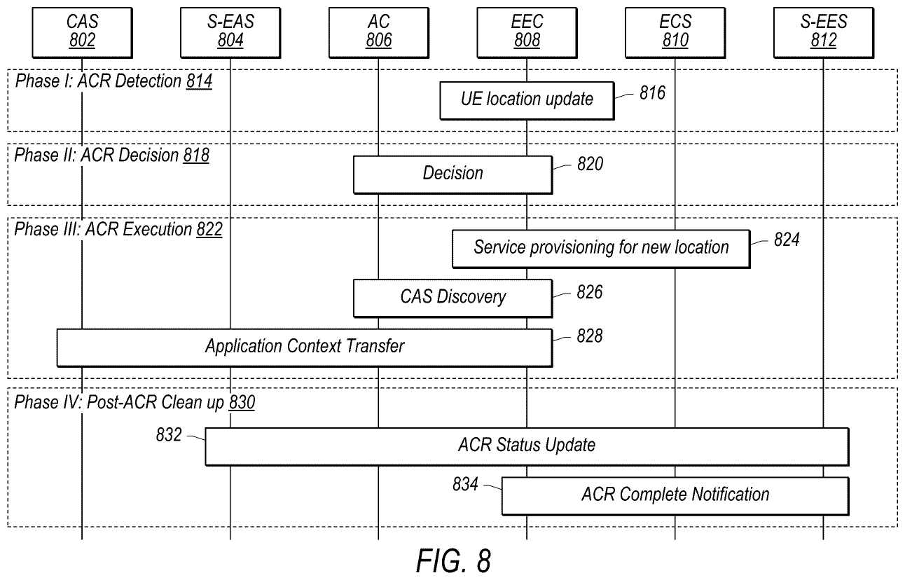

In 706, the UE can receive a response (e.g., a service provisioning message) from an edge configuration server (ECS). As one possibility, the service provisioning message can comprise an indication that a suitable edge data network (EDN) for the UE could not be found in the new service area corresponding to the UE's updated location. For example, as part of the service provisioning procedure, the ECS can responds to the UE with a list of EDN and/or information related to the cloud deployment such as CAS configuration information, according to some embodiments. In other words, since the location of the UE has changed, the service provisioning response can include a list of target EES or configuration information related to the cloud deployment (e.g., the CAS) that are relevant to the applications and the new location of the UE. For example, the configuration information can include addresses, DNNs, S-NSSAI, or service areas of one or more EES, EDN and/or configuration information related to the cloud deployment to which the UE can connect to continue providing service for the application(s). Additionally or alternatively, if the ECS is aware of a suitable EDN, the ECS can provide that information and the UE can determine to perform an application context transfer (ACT) as part of an application context relocation (ACR) to that EDN. According to some embodiments, the EEC of the UE can be configured to receive the response from the ECS. According to some embodiments, the service provisioning procedure can also be triggered by the ECS. For example, the service provisioning procedure can be triggered by the ECS when the UE location is provided by the cellular network to the ECS via the EDGE-8 interface using the UE location application programming interface (API), according to some embodiments. According to this scenario, the steps 816 and 820 in FIG. 8 may not be performed (e.g., they can be skipped or disregarded).

In 708, the UE can discover a suitable CAS corresponding to the second service area. For example, the UE can discover or discern, from the information from the ECS (e.g., from the service provisioning response), a CAS which is relevant or suitable to the application being utilized on the UE, according to some embodiments. Additionally or alternatively, the UE can use the list of EDN or CAS configuration information provided from the ECS in order to discover a suitable CAS. According to some embodiments, a suitable CAS can correspond to a CAS which meets certain service continuity requirements of the application. In some embodiments, the AC and/or EEC of the UE can be configured to discover a suitable CAS for the UE. Additionally or alternatively, the AC can use the FQDN of the CAS via a DNS query to discover the CAS, according to some embodiments.

In 710, the UE can perform an application context transfer (ACT) from the EAS to the CAS. According to some embodiments, the ACT can be part of an application context relocation (ACR) procedure. For example, the UE can be triggered by the EEC to start the application context transfer (ACT). According to some embodiments, the AC of the UE can be configured to perform the ACT upon being triggered by the EEC. Furthermore, the ACT procedure can include establishing a connection to the CAS and initiating an exchange of application data with the CAS rather than continuing to exchange data with the EAS. For example, the UE (or AC of the UE) can decide or determine to initiate the transfer of the application context information from the source edge application server (S-EAS) to the cloud application server (CAS). After the ACT is completed, the AC can remain connected to the CAS and disconnect from the S-EAS, according to some embodiments. Additionally or alternatively, the EEC can be informed notified by the AC of the completion of the successful ACT.

In some embodiments, the S-EAS or CAS can be configured to determine whether or not to terminate or discontinue the ACR. If the ACR is terminated, the CAS can discard the application context information based on information received from the EEL and/or other information corresponding location of the UE, according to some embodiments. According to some embodiments, terminating an ACR can be performed in the scenario in which the ACR has been triggered due to a prediction that the UE would move to a certain location in future, but the UE does not move to this predicted location. For example, the UE can have moved to a different location and can have triggered a different ACR procedure. In other words, the UE can have moved to an area that supports other EDNs rather than the one originally predicted (e.g., which can have supported a CAS). Additionally or alternatively, the application server in the location that the UE was predicted to move to would not yet have a connection with the UE and therefore a disconnection procedure may not be performed, according to some embodiments.

### FIG. 8—Method for Application Context Relocation (ACR) Between Edge Application Server (EAS) and Cloud Application Server (CAS)

FIG. 8 illustrates a phase chart corresponding to an example method for ACR between EAS and CAS, according to some embodiments. More specifically, FIG. 8 describes ACR scenarios and how they can be used in contexts similar to those defined in TS 23.558 clause 8.8.2.2 such that ACR is performed when transitioning from an Edge Application Server (EAS) to a Cloud Application Server (CAS).

In some embodiments, one example scenario of performing ACR between an EAS and a CAS can correspond to initiation by an EEC using regular or typical EAS discovery. More specifically, ACR can be a result of the UE moving to, or the UE expecting to move to, a new location which is outside the service area of the source EAS. Accordingly, the EEC can be triggered to indicate the ACR procedure as a result of the UE's movement as described in TS 23.558 clause 8.8.1.1, for example. Furthermore, this scenario can be based on service provisioning and CAS Discovery (for example, as specified in TS 23.558 clauses 8.3 and 8.5) procedures to discover the EES and CAS that shall serve the AC as a result of the UE's new location and shall receive the application context from the source EAS.

According to some embodiments, pre-existing conditions (e.g., pre-conditions) can be present when performing ACR corresponding to a user equipment (UE) moving from a service area where an EAS is supported to a service area where only CAS can be supported. For example, pre-conditions (for example, as listed in TS 23.558 clause 8.3.3.2.2) with regards to the EEC can be fulfilled, according to some embodiments. According to some embodiments, an additional or alternative pre-condition can correspond to the EEC being triggered when it obtains the UE's new location or has been triggered by another entity (e.g., an ECS notification).

In some embodiments, a first phase (e.g., Phase I, 814) can correspond to a detection of an event related to ACR. More specifically, the UE (or EEC 808 of the UE) can detect one or more UE location updates 816 corresponding to the UE can moving from a service area which supports one or more source edge application servers (S-EAS) 804 to a service area which can only supports one or more cloud application servers (CAS) 802. Additionally or alternatively, the UE can detect the UE location update 816 as a result of a UE mobility event and can further be provided with the UE's new location, according to some embodiments. As one possibility, the UE (or EEC 808 of the UE) can also be able to detect an expected or predicted UE location in the future.

According to some embodiments, a second phase (e.g., Phase II 818) can correspond to a decision 820 regarding the ACR. In some embodiments, the UE (or either the AC 806 or the EEC 808 of the UE) can make the decision 820 (e.g., of whether and/or when) to perform the ACR. Moreover, the UE (or AC 806 or the EEC 808 of the UE) can be able to determine which applications require ACR based on the application profile (e.g., service continuity requirements of the application), according to some embodiments. Additionally or alternatively, if the change in UE's location does not trigger a need to change the source EAS (S-EAS) 804, the UE may not enter the third and fourth phases as discussed below and instead the EEC can remain connected to the source EES(s) (S-EES) 812 and the AC 806 can remain connected to its corresponding source EAS 804.

Additionally or alternatively, if the ACR is triggered by an external entity such as by a notification from the ECS 810, information related to new CASs (e.g., CAS endpoint IP addresses) can also be provided by that notification. For example, one possible way for the CAS information to be shared would be for the ECS to share configuration information of the CAS. Accordingly, if the ACR for has been triggered by the ECS 810, the AC 806 can connect to the target CAS (T-CAS) (e.g., such as CAS 802) when the UE moves to the predicted location. Otherwise, the AC 806 can remain connected to the EAS (e.g., S-EAS 804) as previously configured. In some embodiments, if the ACR has been triggered for service continuity planning but the UE does not move to the expected and/or predicted location, the EEC 808 can remain connected to the S-EES 812 and the AC 806 can remain connected to the S-EAS 804. In other words, third and fourth phases of the ACR process (Phase III-ACR Execution 822 and Phase IV-Post-ACR Clean-up 830) may not be performed.

Additionally or alternatively, a third phase (e.g., Phase III 822) can correspond to the execution of the ACR. In some embodiments, the UE or EEC 808 of the UE can perform service provisioning 824 for active application(s) that require ACR. Moreover, since the location of the UE has changed, the service provisioning procedure 824 can result in a Service Provisioning Response from the ECS 810 to EEC 808 with a failure response, if the ECS 810 does not find any suitable EDNs for service continuity purposes, according to some embodiments. Accordingly, the EEC 808 can then proceed to inform the AC that no suitable EDN has been found. Additionally or alternatively, the service provisioning procedure 824 can result in a list of CAS (e.g., such as CAS 802) that are relevant to the application(s) and the new location of the UE. According to some embodiments, if the ACR for service continuity planning is triggered, then the connectivity information and UE location in the service provisioning procedure 824 can contain expected connectivity information and/or expected UE location.

In some embodiments, the EEC 808 can inform the AC 806 of this information by sending the AC 806 an AC Notification message with an indication of failure to find any EDN. Additionally or alternatively, the EEC 808 can forward the AC the Service Provisioning Response message from the ECS 810, according to some embodiments. In some embodiments, the EEC 808 can send the AC 806 a newly defined message to indicate failure to find any EDNs. Additionally or alternatively, the receipt of this indication by the AC can further trigger available or existing mechanisms in order to discover a CAS (e.g., CAS 802). For example, the AC 806 can use a domain name system (DNS) with a fully qualified domain name (FQDN) to determine the application's internet protocol (IP) address in order to perform CAS discovery 826.

In some embodiments, the UE (or AC 806 of the UE) can be triggered to start the application context transfer (ACT) 828 as part of the ACR. According to some embodiments, the UE (or AC 806 of the UE) can be triggered by the EEC 808 to perform or initiate the ACT 828. Additionally or alternatively, the UE (or AC 806 of the UE) can decide to initiate the transfer of the application context information from the source edge application server (S-EAS) 804 to the cloud application server (CAS) 802. After the ACT 828 is completed, the AC 806 can remain connected to the CAS 802 and disconnect from the S-EAS 804, according to some embodiments. Additionally or alternatively, the EEC 808 can be informed of the completion of the successful ACT 828. According to some embodiments, the S-EAS 804 can be further configured to determine whether or not to terminate or discontinue the ACR. Accordingly, in such an example, the CAS 802 can discard the application context information based on information received from the EEL and/or other information corresponding to location of the UE.

In some embodiments, a fourth phase (e.g., Phase IV 830) can correspond to a Post-ACR clean-up phase. For example, in response to having completed the ACR, the source edge application server (S-EAS) 804 can then send an ACR status update 832 message to the source edge enabler server (S-EES) 812. Additionally or alternatively, if the status update 832 indicates a successful application context transfer (ACT) 828 (e.g., as part of a successfully executed ACR), the S-EES 812 can send an ACR information notification 834 (e.g., a ACR complete message) message to the EEC 808 to confirm that the ACR has been completed. According to some embodiments, if the EEC context relocation procedure (e.g., the ACR) was attempted, the notification (e.g., the ACR complete message 834) can include an EEC context relocation status IE which can indicate the result of the EEC context relocation procedure.

### Additional Information and Embodiments

In some embodiments, a method performed by a user equipment (UE) can include detecting a mobility event of the UE in which corresponds to the UE moving from a first service area which supports one or more edge application servers (EAS) to a second service area which may not support any EAS but instead supports one or more cloud application servers (CAS). The UE can then perform communications with an edge configuration server (ECS) regarding the second service area, according to some embodiments. Additionally or alternatively, the UE can receive from the ECS, a response comprising an indication that one or more suitable edge data networks (EDNs) could not be found, according to some embodiments. In some embodiments, the UE can discover a suitable CAS corresponding to the second service area and perform an application context transfer (ACT) from the EAS to the CAS.

According to some embodiments, the communications with the ECS can include performing a service provisioning procedure corresponding to the second service area. Additionally or alternatively, the service provisioning procedure can include querying the ECS in order to find the one or more suitable EDNs, according to some embodiments. In some embodiments, the service provisioning procedure can be triggered by the ECS when a location of the UE is provided to the ECS by a cellular network entity via an EDGE-8 interface using a UE location application programming interface (API).

According to further embodiments, a suitability of the one or more suitable EDNs can be based on at least one of a location and an application client (AC) profile of the UE. Additionally or alternatively, the response from the ECS can include a service provisioning response, according to some embodiments. In some embodiments, the response can comprise configuration information including at least one of internet protocol (IP) addresses, data network names (DNN), single network slice selection assistance information (S-NSSAI), and service areas corresponding to the suitable CAS of the one or more CAS. Additionally or alternatively, the response can comprise a failure response.

In some embodiments, the UE can comprise an edge enabler client (EEC) and an application client (AC) and the method can further comprise informing, via the EEC, the AC that the one or more suitable EDNs were not found. Additionally or alternatively, the method can further comprise informing, via the EEC, the AC of a failure to find a suitable EDN by sending the AC a notification message with an indication of the failure to find the suitable EDN. According to some embodiments, the method can further comprise forwarding, via the EEC, the response from the ECS to the AC.

In some embodiments, the receipt of the indication by the AC can trigger the discovery of the CAS using available or existing mechanisms. According to some embodiments, the available or existing mechanisms can use a domain name system (DNS) with a fully qualified domain name (FQDN) of the CAS in order to discover the CAS. Additionally or alternatively, the available or existing mechanisms can involve the AC using the fully qualified domain name (FQDN) of the CAS via a domain name system (DNS) query to discover the CAS, according to some embodiments. In some embodiments, the AC can be triggered by the EEC to start the ACT.

According to further embodiments, a method for operating an edge configuration server (ECS) can comprise establishing communication with a user equipment (UE). Additionally or alternatively, the method for operating the ECS can further comprise receiving, from the UE, a message indicating a mobility event of the UE, wherein the mobility event corresponds to the UE moving from a first service area which supports one or more edge application servers (EAS) to a second service area which supports one or more cloud application servers (CAS), according to some embodiments. In some embodiments, the method for operating the ECS can further include transmitting, to the UE, a response comprising at least one of an indication that a suitable EDN could not be found and information corresponding to one or more suitable CAS. Additionally or alternatively, the information corresponding to the one or more suitable CAS can be useable by the UE in performing an application context transfer (ACT) from the EAS to the CAS. As one possibility, the method of operating the ECS can further include receiving, from a cellular network entity and via an EDGE-8 interface using a UE location application programming interface (API), information corresponding to the mobility event of the UE.

In some embodiments, an apparatus comprising a processor can be configured to cause a user equipment to perform a method according to any of the previous examples.

In some embodiments, a user equipment (UE) can comprise a radio and a processor configured to cause the UE to perform a method according to any of the previous examples.

In some embodiments, a computer program product, comprising computer instructions which, when executed by one or more processors, can perform steps of any of the methods described herein.

In various embodiments, various combinations of the embodiments described above can be combined together.

Yet another exemplary embodiment can include a method, comprising: by a wireless device: performing any or all parts of the preceding examples.

Another exemplary embodiment can include a wireless device, comprising: an antenna; a radio coupled to the antenna; and a processing element operably coupled to the radio, wherein the device is configured to implement any or all parts of the preceding examples.

Still another exemplary embodiment can include an apparatus, comprising: a processing element configured to cause a wireless device to implement any or all parts of the preceding examples.

A further exemplary set of embodiments can include a non-transitory computer accessible memory medium comprising program instructions which, when executed at a device, cause the device to implement any or all parts of any of the preceding examples.

A still further exemplary set of embodiments can include a computer program comprising instructions for performing any or all parts of any of the preceding examples.

Yet another exemplary set of embodiments can include an apparatus comprising means for performing any or all of the elements of any of the preceding examples.

Any of the methods described herein for operating a user equipment (UE) can be the basis of a corresponding method for operating a base station, by interpreting each message/signal X received by the UE in the DL as message/signal X transmitted by the base station, and each message/signal Y transmitted in the UL by the UE as a message/signal Y received by the base station. Moreover, a method described with respect to a base station can be interpreted as a method for a UE in a similar manner.

In addition to the above-described exemplary embodiments, further embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106 or 107) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method, comprising:
detecting a mobility event of a user equipment (UE), wherein the mobility event corresponds to the UE moving from a first service area which supports one or more edge application servers (EAS) to a second service area which supports one or more cloud application servers (CAS);
performing communications with an edge configuration server (ECS) regarding the second service area;
receiving, from the ECS, a response comprising an indication that one or more suitable edge data networks (EDNs) could not be found;
discovering, a suitable CAS of the one or more CAS corresponding to the second service area; and
performing, an application context transfer (ACT) from the EAS to the CAS.

2. The method of claim 1, wherein the communications with the ECS comprises performing a service provisioning procedure corresponding to the second service area.

3. The method of claim 2, wherein the service provisioning procedure includes querying the ECS in order to find the one or more suitable EDNs.

4. The method of claim 2, wherein the service provisioning procedure is triggered by the ECS when a location of the UE is provided to the ECS by a cellular network entity via an EDGE-8 interface using a UE location application programming interface (API).

5. The method of claim 1, wherein a suitability of the one or more suitable EDNs is based on at least one of a location and an application client (AC) profile of the UE.

6. The method of claim 1, wherein the response from the ECS is a service provisioning response.

7. The method of claim 1, wherein the response comprises configuration information including at least one of internet protocol (IP) addresses, data network names (DNN), single network slice selection assistance information (S-NSSAI), and service areas corresponding to the suitable CAS of the one or more CAS.

8. The method of claim 1, wherein the response comprises a failure response.

9. The method of claim 1, wherein the UE comprises an edge enabler client (EEC) and an application client (AC) and the method further comprises:
informing, via the EEC, the AC that the one or more suitable EDNs were not found.

10. The method of claim 1, wherein the UE comprises an edge enabler client (EEC) and an application client (AC) and the method further comprises:
informing, via the EEC, the AC of a failure to find a suitable EDN by sending the AC a notification message with an indication of the failure to find the suitable EDN.

11. The method of claim 1, wherein the UE comprises an edge enabler client (EEC) and an application client (AC) and the method further comprises:
forwarding, via the EEC, the response from the ECS to the AC.

12. The method of claim 1, wherein the UE comprises an edge enabler client (EEC) and an application client (AC) and wherein the receipt of the indication by the AC triggers the discovery of the CAS using available or existing mechanisms.

13. The method of claim 12, wherein the available or existing mechanisms involve using a domain name system (DNS) with a fully qualified domain name (FQDN) of the CAS in order to discover the CAS.

14. The method of claim 12, wherein the available or existing mechanisms involve using the AC using the fully qualified domain name (FQDN) of the CAS via a domain name system (DNS) query to discover the CAS.

15. The method of claim 1, wherein the UE comprises an edge enabler client (EEC) and an application client (AC) and wherein the AC is triggered by the EEC to start the ACT.

16. A method for operating an edge configuration server (ECS), the method comprising:
establishing communication with a user equipment (UE);
receiving, from the UE, a message indicating a mobility event of the UE, wherein the mobility event corresponds to the UE moving from a first service area which supports one or more edge application servers (EAS) to a second service area which supports one or more cloud application servers (CAS);
transmitting, to the UE, a response comprising at least one of an indication that a suitable EDN could not be found and information corresponding to one or more suitable CAS,
wherein the information corresponding to the one or more suitable CAS is useable by the UE in performing an application context transfer (ACT) from the EAS to the CAS.

17. The method of claim 16, further comprising:
receiving, from a cellular network entity and via an EDGE-8 interface using a UE location application programming interface (API), information corresponding to the mobility event of the UE.

18. An apparatus, comprising:
a processor configured to, when executing instructions stored in a memory, perform operations comprising:
detecting a mobility event of a user equipment (UE), wherein the mobility event corresponds to the UE moving from a first service area which supports one or more edge application servers (EAS) to a second service area which supports one or more cloud application servers (CAS);
performing communications with an edge configuration server (ECS) regarding the second service area;
receiving, from the ECS, a response comprising an indication that one or more suitable edge data networks (EDNs) could not be found;
discovering, a suitable CAS of the one or more CAS corresponding to the second service area; and
performing, an application context transfer (ACT) from the EAS to the CAS.

19. The method of claim 18, wherein the communications with the ECS comprises performing a service provisioning procedure corresponding to the second service area.

20. The method of claim 19, wherein the service provisioning procedure includes querying the ECS in order to find the one or more suitable EDNs.
